(19) United States
(12) Patent Application Publication
(10) Pub. No.: US 2014/0176255 A1
(43) Pub. Date: Jun. 26, 2014

(54) Compact micro strip directional coupler with high directivity for broadband applications

(71) Applicants: Kameswara Rao Balijapalli, Chennai (IN); Ravi Kishore, Chennai (IN); Kumaralingam Ramamoorthy, Chennai (IN); Karthikeyan Shanmugavelu, Chennai (IN); Deepa Vedhanayagam, Chennai (IN)

(72) Inventors: Kameswara Rao Balijapalli, Chennai (IN); Ravi Kishore, Chennai (IN); Kumaralingam Ramamoorthy, Chennai (IN); Karthikeyan Shanmugavelu, Chennai (IN); Deepa Vedhanayagam, Chennai (IN)

(21) Appl. No.: 13/723,225

(22) Filed: Dec. 21, 2012

(51) Int. Cl. H01P 5/18

(52) U.S. Cl. CPC H01P 5/184
USPC 333/116

(57) ABSTRACT

The directional coupler supports ultra high bandwidth of 5600 MHz (from 400 MHz to 6 GHz) in compact structure and also provides high directivity of (>15 dB). The coupler uses a two stage micro-strip directional coupler for a frequency range of 400 MHz to 6 GHz, where the first stage supports a frequency of operation from 0.4 to 1 GHZ and the second stage supports a frequency of operation from 1 GHz to 6 GHz and the required coupled port can be chosen using a radio frequency switch as required by the application used in.

The present application is based on, and claims priority from, IN Application Number 2421/CHE/2012, filed on Jun. 19, 2012, the disclosure of which is hereby incorporated by reference herein.

### TECHNICAL FIELD

This embodiment relates to wideband directional coupler and more particularly to a compact directional coupler with high directivity and capable of operating on ultra-high bandwidth.

### BACKGROUND

Directional couplers are passive radio frequency components used in radio frequency and microwave signal routing for isolating, separating or combining signals. With advances in telecommunications and wireless technologies, directional couplers are required to support wide bandwidth, have high directivity, better coupling and provide better isolation.—Microstrip based directional couplers have proven to be compact with ease to integrate and hence popular.

However, inmost directional couplers, there is a trade-off between bandwidth, directivity and compactness. This trade off works satisfactorily in case of narrow band or for extremely high frequencies and provides high directivity along with compactness.

### SUMMARY

Accordingly the embodiment provides a compact microstrip directional coupler providing high directivity and capable of operating over an ultra-high bandwidth comprising of a first stage and second stage coupler. The first stage coupler operates over a frequency range of 0.4 GHz to 1 GHz and the second stage. The second stage coupler operates over a frequency range of 1 to 6 GHz. A radio frequency switch is used to select between the first stage and second coupler based on the input frequency.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

This embodiment is illustrated in the accompanying drawings, throughout which like reference letters indicate corresponding parts in the various figures. The embodiments herein will be better understood from the following description with reference to the drawings, in which:

FIG. 1 illustrates a block diagram of the microstrip directional coupler, according to the embodiments as disclosed herein;

FIG. 2 shows the first stage directional coupler, according to embodiments disclosed herein;

FIG. 3 shows the second stage directional coupler, according to embodiments disclosed herein;

FIG. 4 shows the s- parameters of first stage coupler operating over 1 to 6 GHz simulated over 0.4 to 6 GHz, according to embodiments disclosed herein;

FIG. 5 shows the s- parameters of second stage coupler operating over 0.4 to 1 GHz simulated over 0.4 to 6 GHz, according to embodiments disclosed herein; and

FIG. 6 shows the simulated s- parameters of integrated coupler (first stage+second stage) operating over 0.4 to 6 GHz, according to embodiments disclosed herein.

### DETAILED DESCRIPTION OF EMBODIMENTS

The embodiments herein, the various features, and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

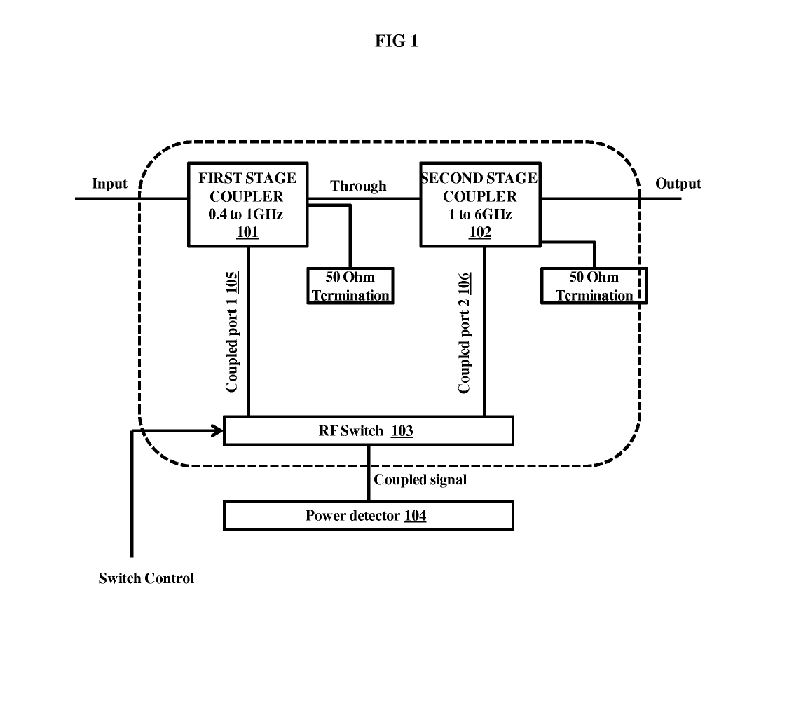

Referring now to the drawings, and more particularly to FIGS. 1 through 6, where similar reference characters denote corresponding features consistently throughout the figures, there are shown preferred embodiments.

FIG. 1 illustrates a block diagram of an integrated microstrip directional coupler, according to the embodiments as disclosed herein. The integrated directional coupler comprises of multiple stages of directional couplers. The first stage directional coupler 101 operates over a frequency range of 0.4 to 1 GHz and the second stage directional coupler operates over a frequency range of 1 to 6 GHz. The coupled port of the integrated directional coupler connects to an RF switch 103. The figure shows an example application of a power detector 104 connected to an as per the system. Appropriate 50 Ohms termination to the isolation ports is also shown in the figure. As per the system need say for power detection, if the coupled signal from 0.4 GHz to 1 GHz is required the coupled signal from the first stage of the coupler can be routed to the Power detector 104 using the RF Switch 103. Similarly, if the signal from 1 GHz to 6 GHz is required, the couple signal from the second stage of the coupler will be routed to the power detector 104 using the RF switch 103. Thus, the coupler could satisfactorily work for the broadband of 0.4 GHz to 6 GHz. The RF switch can be controlled using an external control. The directional coupler supports ultra high bandwidth of 5600 MHz (from 400 MHz till 6 GHz) in compact structure and also provide high directivity of >15 dB. The directional coupler is compact enough and is suitable to be incorporated as a Monolithic Microwave Integrated Circuit (MMIC). The compactness in size is achieved using unique approach of combining the two stages. The realizable physical size is approximately 27 mm*51 mm*1.6 mm.

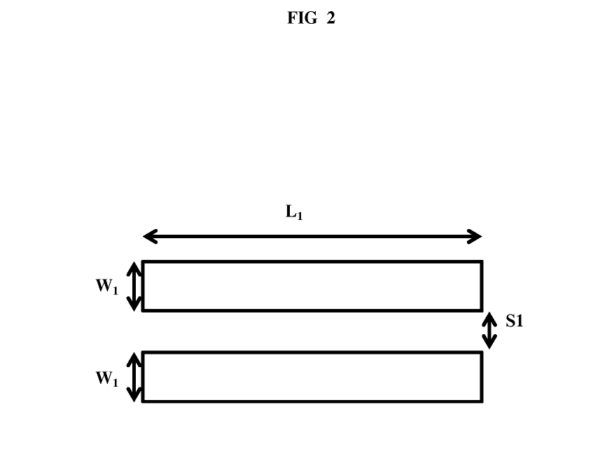

FIG. 2 shows the first stage directional coupler, according to embodiments disclosed herein. The first stage directional coupler 101 comprises of a single section −20 dB coupled line coupler and is designed with meandered structure over the frequency range of 0.4 to 1 GHZ. This frequency range has been found to be a suitable option for achieving the design target. The dimensions of the microstrip-coupled lines are W1, L1 and S1. The values of W1, L1 and S1 are chosen based on results required. The upper arm receives the wideband input and acts as a through arm, while the lower produces the coupled output.

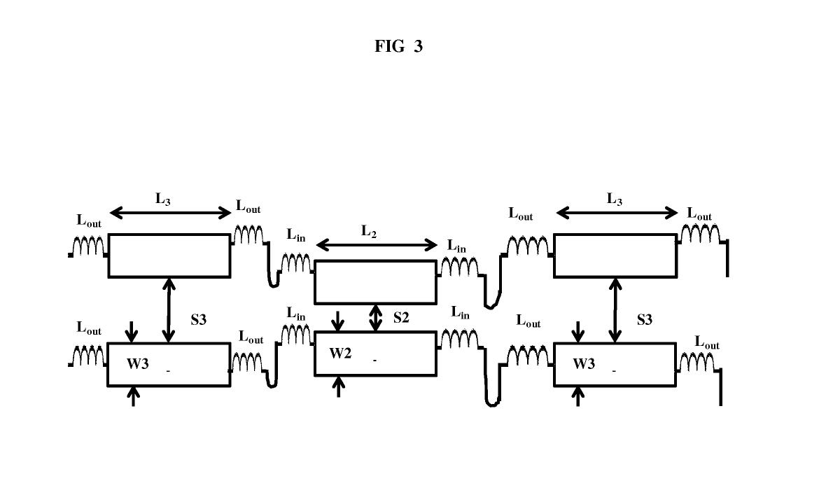

FIG. 3 shows the second stage directional coupler, according to embodiments disclosed herein. For the second stage coupler 102 operating over 1 to 6 GHZ, a three section −20 dB maximally flat couplers design based on quadrupled inductive compensated micro strip coupled lines is used for directivity improvement. The required optimum Inductor for the inner and outer coupled-Line section are L_{In} and Lₒᵤₜ. The dimensions of the microstrip coupled lines for the first and the third sections are found to be W3, S3 and L3. The dimension of the mictrostrip couple lines for the second section is W2, S2 and L2.

As two separate stages supporting 400 MHz to 1000 MHz and 1000 MHz to 6000 MHz are combined, the required coupled port can be chosen using switch. A high directivity of 15 dB is achieved using the integrated approach for ultrawide bandwidth of 5600 MHz. The compact, ultra high-bandwidth and high directivity microstrip directional coupler is majorly applicable in broadband transceivers/broadband transmitters/broadband receivers. In these systems, the embodiment can be used as the major component in signal/power detection circuitry.

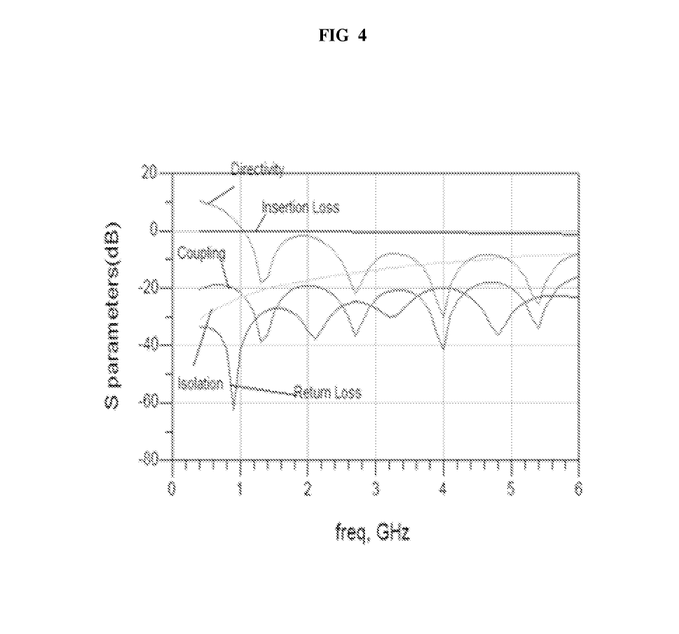

FIG. 4 shows the s- parameters of first stage coupler operating over 0.4 to 1 GHz simulated over 0.4 to 6 GHz, according to embodiments disclosed herein.

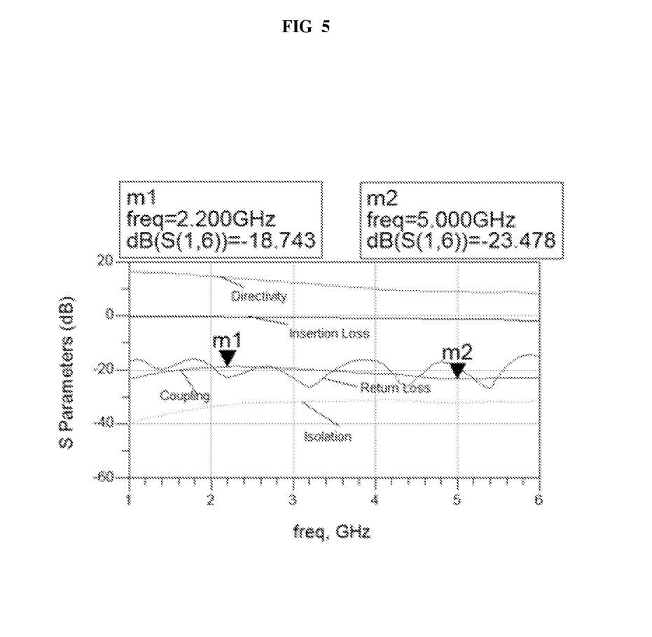

FIG. 5 shows the s- parameters of second stage coupler operating over 1 to 6 GHz simulated over 0.4 to 6 GHz, according to embodiments disclosed herein.

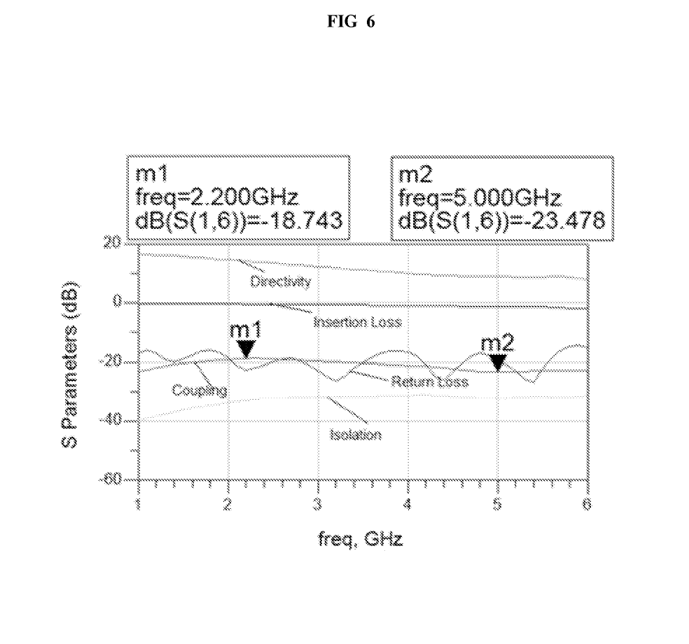

FIG. 6 shows the simulated s- parameters of integrated coupler (first stage+second stage) operating over 0.4 to 6 GHz, according to embodiments disclosed herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A compact microstrip directional coupler providing high directivity and capable of operating over an ultra-high bandwidth comprising of:
a first stage coupler operating at 0.4 to 1 GHz;
a second stage coupler operating at 1 to 6 GHz; and
a radio frequency switch to select between said first stage and said second stage.

2. The compact microstrip directional coupler of claim 1, wherein said first stage and second stage couplers coupler are connected through a through arm.

3. The compact microstrip directional coupler of claim 1, wherein said radio frequency switch selects between the first stage coupler and second stage coupler based on the frequency of the input signal.
